(19) United States
(12) Patent Application Publication
(10) Pub. No.: US 2004/0196752 A1
(43) Pub. Date: Oct. 7, 2004

(54) Disk-anchoring device for optical disk drives

(76) Inventor: Kuo Tsung-Jung, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/791,052

(22) Filed: Mar. 1, 2004

(30) Foreign Application Priority Data
Apr. 2, 2003 (TW) 92205293

(51) Int. Cl. G11B 7/00; G11B 3/20

(52) U.S. Cl. 369/30.31; 369/30.32; 369/30.43

(57) ABSTRACT

A disk-anchoring device for use in an optical disk drive to receive and locate an optical disk includes a substrate, a clamper, a clamper frame, a clamper holder, an elastic element, a frame clamper and a rack slider. The clamper frame has a first protrusion portion. The rack slider has an inclined portion and a second protrusion portion. The elastic element is elastically positioned on the substrate and can function to press down the clamper frame. When the optical disk is loaded, the rack slider can move to have the first protrusion portion of the clamper frame abut the second protrusion portion of the rack slider. The optical disk positioned in the optical disk drive can then be hold elastically and accurately by the clamper, the elastic element, and abutment between the first protrusion portion of the clamper frame and the second protrusion portion of the sliding plate.

### BACKGROUND OF THE INVENTION

(1) Field of the Invention

The present invention relates to an optical disk device, and more particularly to a disk-anchoring device for use in a slot-in optical disk device that can receive and anchor an optical disk without a protrusion tray.

(2) Description of the Prior Art

In ordinary life, optical disk drives can be usually seen in various electronic devices, such as desktop computers, notebook computers, car CD players and so on. Among various types of optical disk drives, the slot-in optical disk drive which allows a user to load and unload an optical disk directly through a slot, not a protrusion tray, is a much easier and more convenient design to the users.

Referring to FIG. 1, a typical conventional slot-in optical disk drive 91 is perspectively shown. As shown, a disk 9a is at a state of loading into the conventional slot-in optical disk drive 91 through an opening 92. In a particular situation, as soon as the disk 9a is loaded into the conventional slot-in optical disk drive 91, a notorious noise may arise due to high-speed spinning of the optical disk 9a with a mis-located disk 9a inside the slot-in optical disk drive 91. As a result, a reading error may occur and fail the attempt to read the optical disk 9a.

Accordingly, it is a need for the skill in the art to develop an optical disk-anchoring device that can handle the optical disk steadfastly and accurately.

### SUMMARY OF THE INVENTION

Accordingly, it is a primary object of the present invention to provide an optical disk-anchoring device that can load and unload the optical disk steadfastly and accurately in a slot-in optical disk drive.

It is another object of the present invention to provide a disk-anchoring device to an optical disk drive that can hold properly an optical disk while the optical disk drive is in use.

According to the present invention, the disk-anchoring device includes a substrate, a clamper having a magnetic element for fixing an optical disk, a clamper frame, a clamper holder, a frame clamper, a rack slider and an elastic element. The clamper frame has a first protrusion portion and a clamping flange. The rack slider has an inclined portion and a second protrusion portion. The elastic element is elastically positioned on the substrate and functions to make the clamper frame capable of being pushed downwardly.

When the optical disk is loaded, the rack slider can move to have the first protrusion portion of the clamper frame abut the second protrusion portion of the rack slider. The optical disk is accurately hold by the clamper and resilience provided by the elastic element, and also by abutment between the first protrusion portion of the clamper frame and the second protrusion portion of the rack slider while the optical disk drive is in use.

All these objects are achieved by the disk-anchoring device for optical disk drives described below.

### BRIEF DESCRIPTION OF THE DRAWINGS

The present invention will now be specified with reference to its preferred embodiment illustrated in the drawings, in which

FIG. 1 is a perspective view of a conventional slot-in optical disk drive;

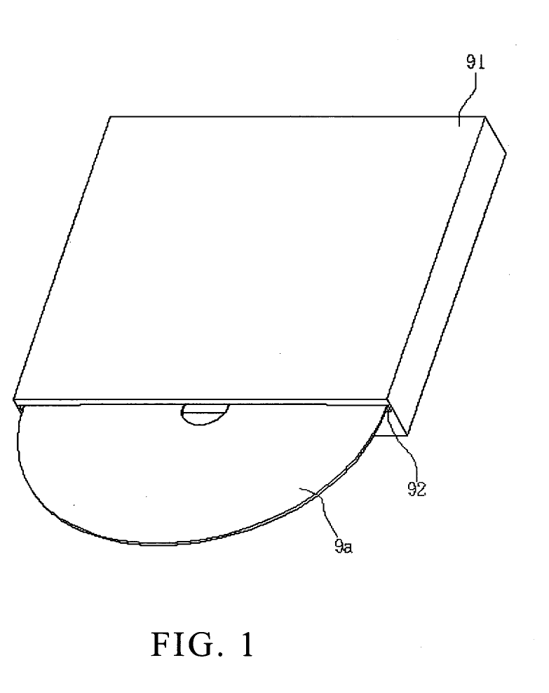

FIG. 2 is a perspective component view of major elements of a preferred optical disk-anchoring device according to the present invention;

FIG. 3 is a perspective view of a preferred substrate for the preferred optical disk-anchoring device of FIG. 2;

FIG. 4A is a perspective view of the preferred optical disk-anchoring device in an assembly state before an optical disk is loaded;

FIG. 4B is a plan view of the preferred optical disk-anchoring device of FIG. 4A;

FIG. 5A is a perspective view of the preferred optical disk-anchoring device in another state after the optical disk is loaded;

FIG. 5B is a plan view of the preferred optical disk-anchoring device of FIG. 5A;

FIG. 6 is an another perspective view of FIG. 4A, but with the frame clamper removed; and

FIG. 7 is an another perspective view of FIG. 5A, but with frame clamper removed.

### DESCRIPTION OF THE PREFERRED EMBODIMENT

The invention disclosed herein is directed to an optical disk-anchoring device for optical disk drives. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, the slot-in optical disk drive for mounting the optical disk-anchoring device can be a CD-ROM drive, a CD-RW drive, a DVD-R/RW drive, a half-height disk drive, a COMBO drive, a car audio player, an external drive, or the like optical media recorder or player.

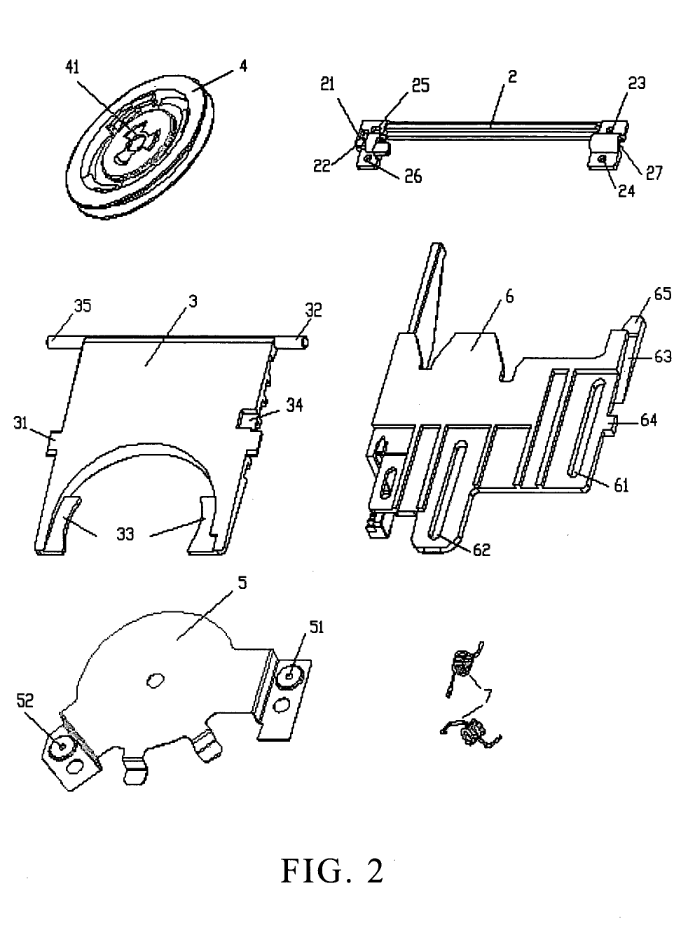

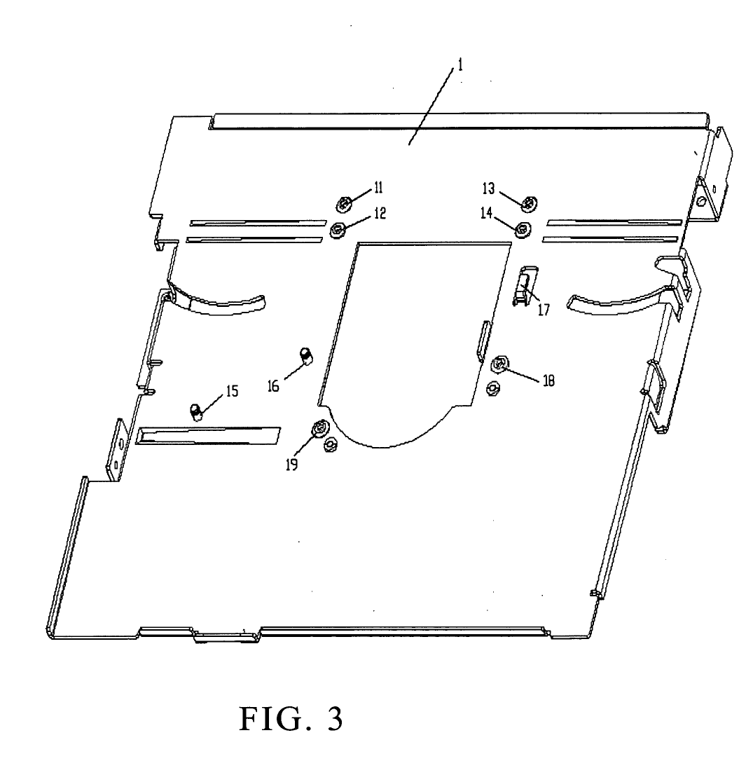

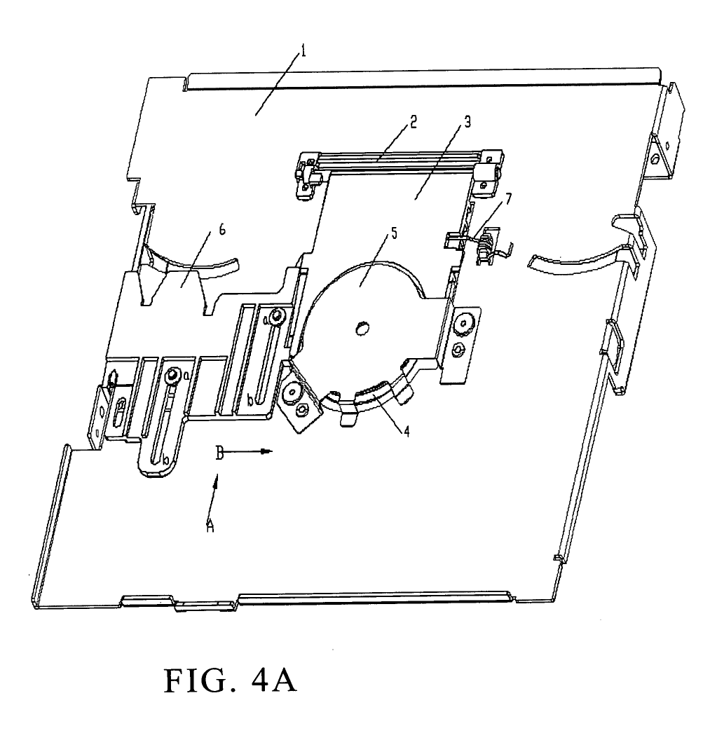

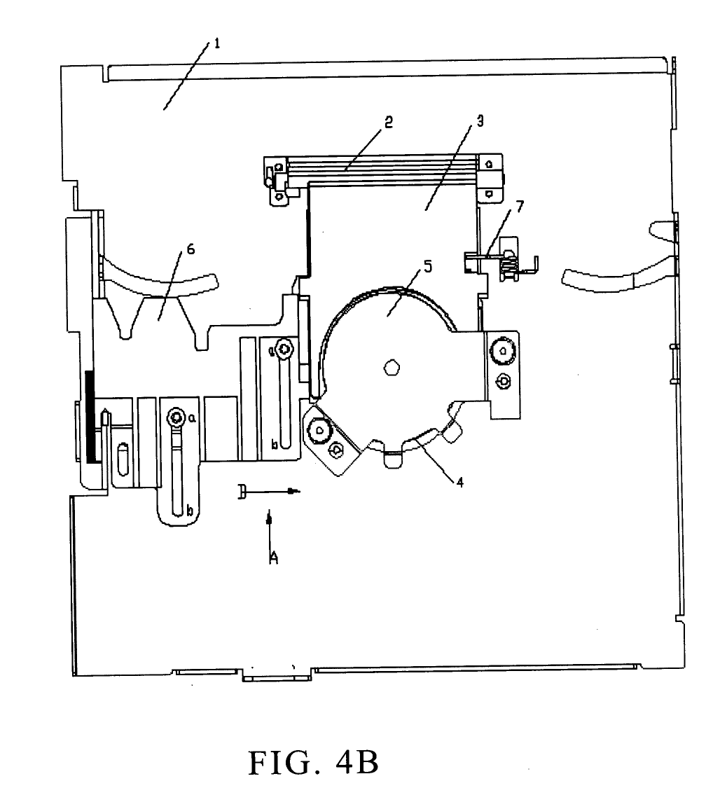

Refer now to FIG. 2, FIG. 3, FIG. 4A and FIG. 4B; in which FIG. 2 illustrates major parts of a preferred disk-anchoring device according to the present invention but without a substrate, however FIG. 3 illustrates a preferred substrate for FIG. 2, FIG. 4A shows an assembly state of the preferred optical disk-anchoring device by integrating parts shown in FIG. 2 and FIG. 3, and FIG. 4B on the other hand shows a plan view of the FIG. 4A.

As shown, the disk-anchoring device according to the present invention can have a substrate 1, a clamper holder 2, a clamper frame 3, a clamper 4, a frame clamper 5, a rack slider 6 and an elastic element 7.

In FIG. 3, the substrate 1 has a plurality of guiding pillars (two as labeled 15 and 16 in the figure), a plurality of locking holes (four as labeled 11, 12, 13, 14, 18 and 19 in the figure) and a positioning hook 17.

In FIG. 2 and FIG. 3, the clamper holder 2 has a plurality of locking holes (four as labeled 23, 24, 25 and 26 in the figure), an elastic arm 21, a pressing chunk 22 and an arched portion 27. The locking holes 23, 24, 25 and 26 are in alignment respectively with the locking holes 13, 14, 11 and 12 of the substrate 1 so that the clamper holder 2 can be fixedly positioned to the substrate 1 by screws or the like fasteners (not shown).

The clamper frame 3 has a first end portion 35, a second end portion 32 opposing to the first end 35, a recessed portion 34, a first protruding portion 31 and a clamping flange 33. The arched portion 27 of the clamper holder 2 is properly sized to receive the second end portion 32 of the clamper frame 3 so that the clamper frame 3 can be pivotally coupled to the clamper holder 2. In addition, the pressing chunk 22 and the elastic arm 21 of the clamper holder 2 are used to depress the first end portion 35 of the clamper frame 3 so as to maintain a forcing along a direction B of FIG. 4A for elastically depressing the clamper frame 3.

Further referring to FIG. 2 and FIG. 3, the clamper 4 including an internal magnetic element 41 can be rotationally coupled to the clamper frame 3. In addition, the frame clamper 5 having the locking holes 51 and 52 to match with the locking holes 18 and 19 of the substrate 1 can be fixed to the substrate 1 by screws or appropriate fasteners (not shown). In an assembly state of the optical disk-anchoring device, the magnet element 41 of the clamper 4 is naturally adhered to the metallic frame clamper 5.

The rack slider 6 as shown includes a plurality of guide grooves (two as labeled 61 and 62 in the figure), an inclined portion 63, a second protruding portion 64 and a third protruding portion 65. The guiding pillars 15 and 16 of the substrate 1 are respectively adapted to travel synchronically within the guide grooves 62 and 61. Before the optical disk is loaded as shown in FIG. 4A, the guiding pillars 15 and 16 of the substrate 1 are located at Positions a of the guide grooves 62 and 61, respectively. On the other hand, after the optical disk is loaded as shown in FIG. 4B, the guiding pillars 15 and 16 of the substrate 1 are moved to Positions b of the guide grooves 62 and 61, respectively. In addition, the elastic element 7 removably hooked to the positioning hook 17 can be a spring or the like elastic part. Also, the elastic element 7 can be made of plastics or metals.

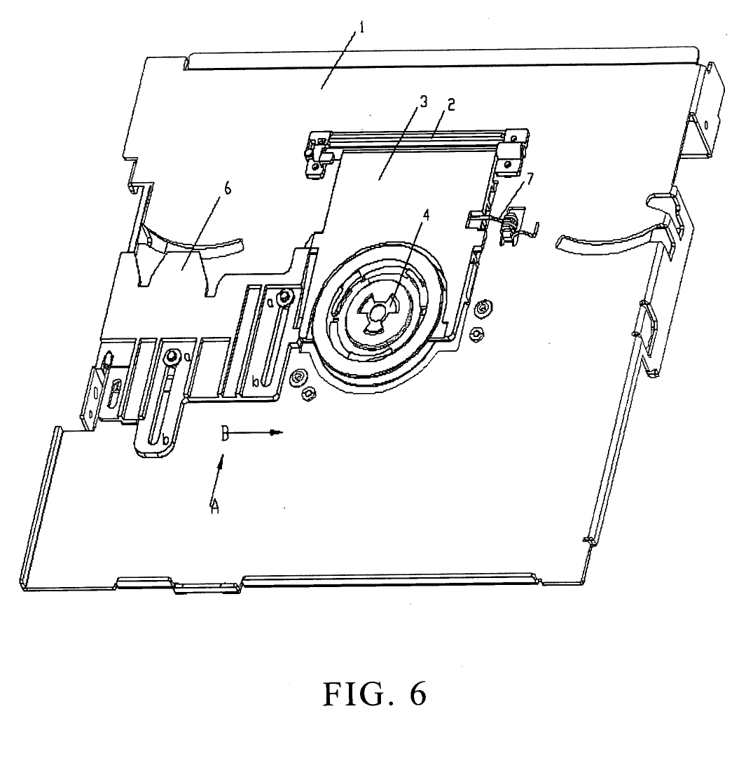

In FIG. 4A, a perspective view of the optical disk-anchoring device before the optical disk is loaded is shown. In FIG. 4B, a schematic plan view of the optical disk-anchoring device of FIG. 4A is shown. Also, referring to FIG. 6, another perspective view of the optical disk-anchoring device of FIG. 4A is illustrated to have the frame clamper 5 removed for showing the clamper 4 located thereunder. As shown, the clamper 4 is rotationally coupled to the clamper frame 3 by the clamping flange 33. When the loading of the optical disk is not complete or the optical disk is ejected, the guiding pillars 15 and 16 are anchored respectively at one ends (as indicated by Position a in FIG. 4) of the guide grooves 62 and 61 of the rack slider 6.

Also as shown, at the state of no disk in the optical disk-anchoring device, the first protrusion portion 31 of the clamper frame 3 is contacted with the third protrusion portion 65 of the rack slider 6, and the recessed portion 34 of the clamper frame 3 receives one end (the left end in the figure) of the elastic element 7 after the elastic element 7 is hooked to the positioning hook 17.

Upon such an arrangement described above, the elastic element 7 can function to continuously depress the clamper frame 3 to have the clamper frame 3 separate from the substrate 1, and the magnetic element 41 of the clamper 4 can attract and further contact the clamper guard 5. In addition, the clamper frame 3 can be pushed along the direction B by the resilience of the elastic arm 21 of the clamper holder 2. Thereby, the clamper frame 3 and the clamper 4 can be kept separately by a spacing with the frame clamper 5 such that the introducing of the optical disk into the optical disk-anchoring device thereafter can be successful without any interruption.

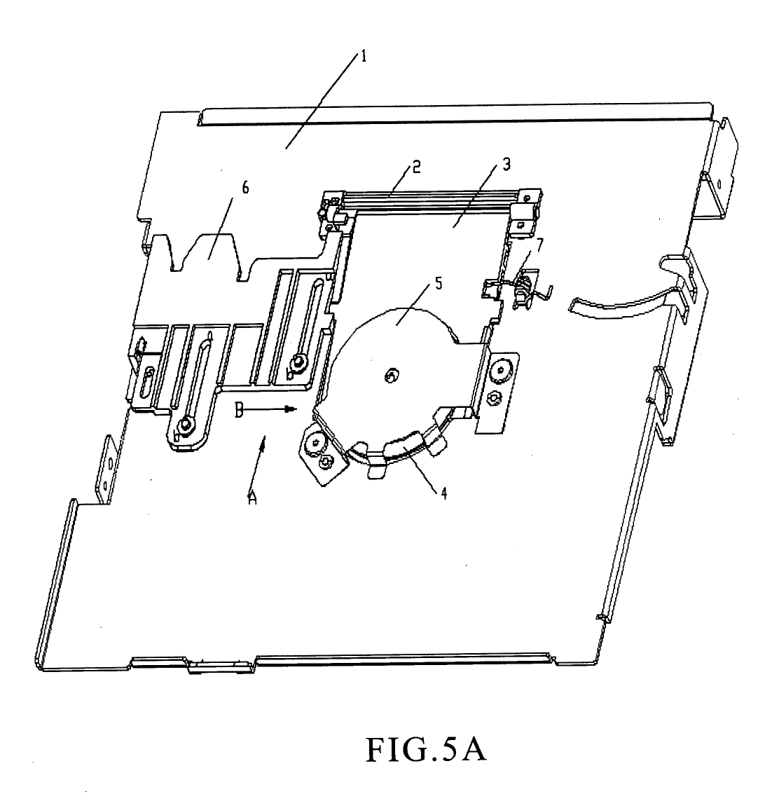

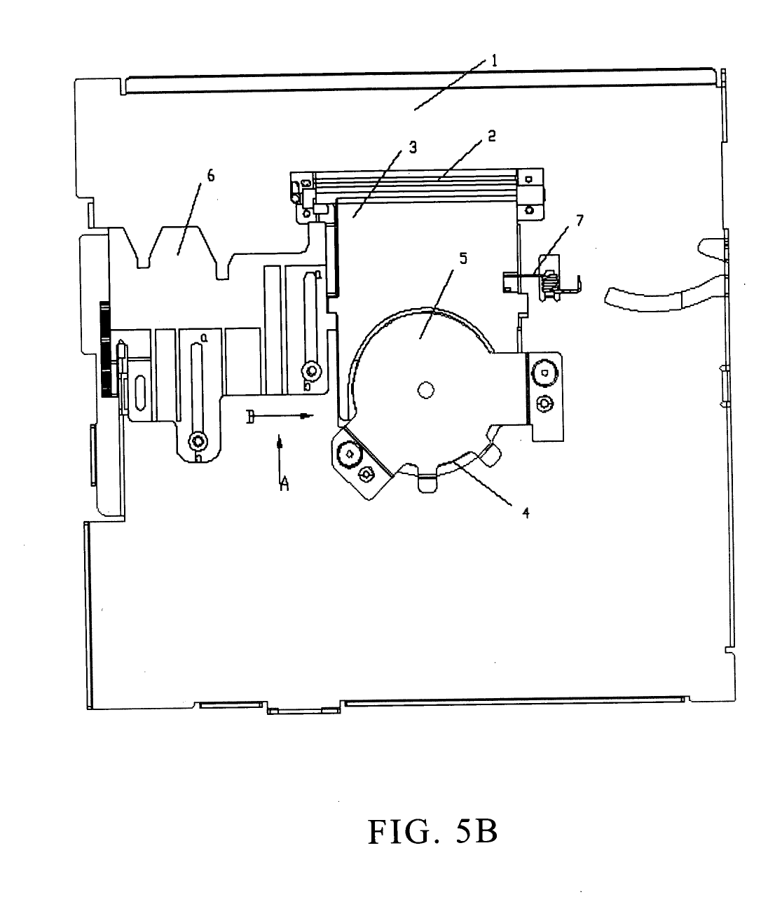

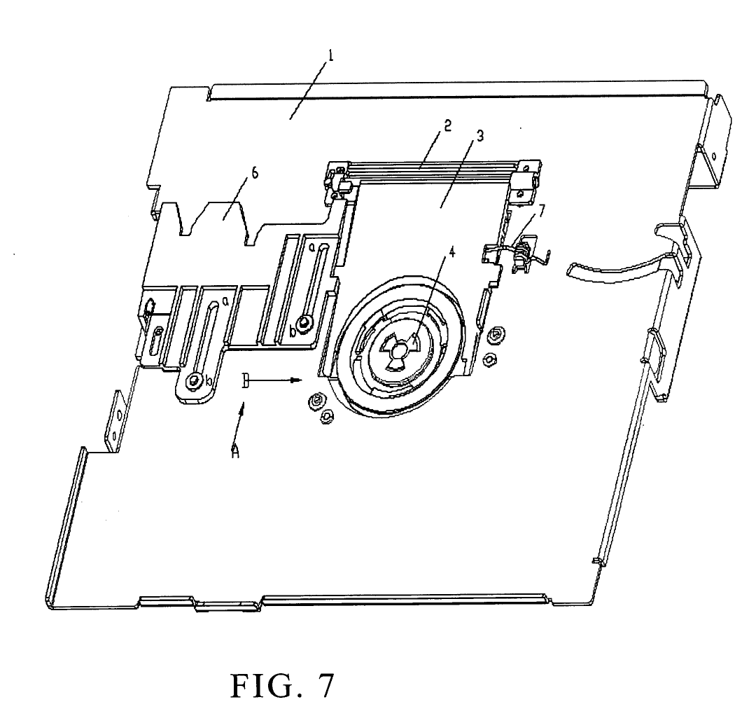

Referring now to FIG. 5A, a perspective view of the optical disk-anchoring device after the optical disk is loaded is shown. FIG. 5B illustrates a schematic plan view of FIG. 5A. Also, refer to FIG. 7 which illustrates another perspective view of FIG. 5A but removing the frame clamper 5 is shown. As shown, when the optical disk is completely introduced to the optical disk-anchoring device, the rack slider 6 is pulled by a gear transmission system (not shown) along a direction A of FIG. 5A. The rack slider 6 will not stop until the guiding pillars 15 and 16 contact respectively with the ends (as indicated by Positions b) of the guide grooves 62 and 61 of the rack slider 6.

In the present invention, as the rack slider 6 moves between Position a and Position b, the first protrusion portion 31 of the clamper frame 3 and the third protrusion portion 65 of the rack slider 6 is not contacted, the first protrusion portion 31 of the clamper frame 3 slides still along the inclined portion 63 of the rack slider 6, and the clamper 4 is not in contact with the frame clamper 5 for the clamper frame 3 is pivotally coupled to the clamper holder 2 and the elastic element 7 is there.

When the rack slider 6 comes to stop, the guiding pillars 15 and 16 respectively contact the other ends (Positions b as indicated) of the guide grooves 62 and 61 of the rack slider 6. At this moment, the second protrusion portion 64 of the rack slider 6 abuts the first protrusion portion 31 and pushes the clamper 4 downwardly so that the clamper frame 3 can be pivoted about the clamper holder 2 to the utmost. In addition, the clamper frame 3 is also pushed along the direction B due to the resilience of the elastic arm 21 of the clamper holder 2. Upon such an arrangement, the optical disk can be kept in place and placed within the optical disk drive with the interconnection among the clamper frame 3, the clamper 4, the rack slider 6 and the elastic element 7.

While the present invention has been particularly shown and described with reference to a preferred embodiment, it will be understood by those skilled in the art that various changes in form and detail may be without departing from the spirit and scope of the present invention.

I claim:

1. A disk-anchoring device of an optical disk device, comprising:
a substrate;
a clamper for fixing a disk, further having a magnetic element;
a clamper frame for holding the clamper, mounted on the substrate and further having thereof a first protruding portion;
a clamper holder for fixing the clamper frame, mounted on the substrate;
a frame clamper for attracting the clamper, mounted on the substrate;
a rack slider, mounted on the substrate and having thereof an inclined portion and a second protruding portion; and
an elastic element, movably hooked to the substrate;
wherein the second protrusion portion of the rack slider is used to abut the first protrusion portion of the clamper frame and the first protrusion portion is scheduled to rest on the inclined portion.

2. The disk-anchoring device as claimed in claim 1, wherein the elastic element is a spring.

3. The disk-anchoring device as claimed in claim 1, wherein the substrate further comprises a plurality of locking holes for positioning the clamper frame, the clamper holder and the frame clamper.

4. The disk-anchoring device as claimed in claim 1, wherein the substrate further comprises a plurality of guiding pillars for guiding the rack slider while in introducing or ejecting the optical disk.

5. The disk-anchoring device as claimed in claim 1, wherein the substrate further comprises a positioning hook for placing the elastic element.

6. The disk-anchoring device as claimed in claim 1, wherein the first protrusion portion of the clamper frame slides along the inclined portion of the rack slider after the rack slider begins to move and before the rack slider stops; and, when the rack slider stops, wherein the second protrusion portion of the rack slider abuts the first protrusion portion and pushes the clamper downwardly so that the clamper frame pivots about the clamper holder to the utmost.

7. The disk-anchoring device as claimed in claim 1, wherein the clamper holder further comprises an elastic arm and a pressing chunk which is used to depress the clamper holder with resilience provided by the elastic arm.

8. The disk-anchoring device as claimed in claim 1, wherein the rack slider further comprises a plurality of guide grooves to be traveled along by the respective guiding pillars of the substrate.

9. The disk-anchoring device as claimed in claim 4, wherein the rack slider further comprises a plurality of guide grooves to be traveled along by the respective guiding pillars of the substrate.

10. A disk-anchoring device for using in an optical disk device, comprising:
a substrate;
a clamper for fixing the disk, further having a magnetic element;
a clamper frame for holding the clamper, mounted on the substrate and further having thereof a first protruding portion;
a clamper holder for fixing the clamper frame, mounted on the substrate;
a frame clamper for adhering the clamper, mounted on the substrate; and
a rack slider, slidably mounted on the substrate and having thereof an inclined portion and a second protruding portion;
wherein the second protrusion portion of the rack slider is used to abut the first protrusion portion of the clamper frame and the first protrusion portion is scheduled to rest on the inclined portion.

11. The disk-anchoring device as claimed in claim 10, wherein the substrate further comprises a plurality of locking holes for positioning the clamper frame, the clamper holder and the frame clamper.

12. The disk-anchoring device as claimed in claim 10, wherein the substrate further comprises a plurality of guiding pillars for guiding the rack slider while in introducing or ejecting the optical disk.

13. The disk-anchoring device as claimed in claim 10, further comprising an elastic element which is movably hooked to the substrate.

14. The disk-anchoring device as claimed in claim 13, wherein the elastic element is a spring.

15. The disk-anchoring device as claimed in claim 10, wherein the substrate further comprises a positioning hook for placing the elastic element.

16. The disk-anchoring device as claimed in claim 10, wherein the first protrusion portion of the clamper frame slides along the inclined portion of the rack slider after the rack slider begins to move and before the rack slider stops; and, when the rack slider stops, wherein the second protrusion portion of the rack slider abuts the first protrusion portion and pushes the clamper downwardly so that the clamper frame pivots about the clamper holder to the utmost.

17. The disk-anchoring device as claimed in claim 10, wherein the clamper holder further comprises an elastic arm and a pressing chunk which is used to depress the clamper holder with resilience provided by the elastic arm.

18. The disk-anchoring device as claimed in claim 10, wherein the rack slider further comprises a plurality of guide grooves to be traveled along by the respective guiding pillars of the substrate.

19. The disk-anchoring device as claimed in claim 12, wherein the rack slider further comprises a plurality of guide grooves to be traveled along by the respective guiding pillars of the substrate.
